(19) United States
(12) Patent Application Publication
(10) Pub. No.: US 2003/0179087 A1
(43) Pub. Date: Sep. 25, 2003

(54) Mirror mounted turn signal light

(76) Inventor: Alwin J. Stahel, St. Paul, MN (US)

Correspondence Address: Nickolas E. Westman, WESTMAN CHAMPLIN & KELLY, International Centre - Suite 1600, 900 South Second Avenue, Minneapolis, MN, 55402-3319, US

(21) Appl. No.: 10/256,310

(22) Filed: Sep. 27, 2002

Related U.S. Application Data
(60) Provisional application No. 60/366,453, filed on Mar. 21, 2002.

(51) Int. Cl. B60Q 1/34

(52) U.S. Cl. 340/475

(57) ABSTRACT

A mirror mounted turn signal for a vehicle having an exterior mirror has a light support housing that is attached to an outer side edge of the mirror. The light support housing mounts a LED strip of lights along an outer side of the support housing. The lights are positioned to direct light rearwardly and along the outer side of a housing wall. The housing wall extends rearwardly beyond the lights and is formed to provide an opaque shield to prevent light from shining in a selected direction. In the form shown the turn signal is on a motorcycle mirror and the eyes of a rider of the motorcycle are shielded from the flashing turn signal light. Super bright LEDs that are highly visible are used. Mounting the turn signal on the rear view mirror places the lights at a level so they are easily seen by drivers of vehicles along side and to the rear of the motorcycle.

This application is based on and claims the benefit of priority on U.S. provisional patent application Serial No. 60/366,453, filed Mar. 21, 2002, the content of which is hereby incorporated by reference.

### BACKGROUND OF THE INVENTION

The present invention relates to an exterior mirror mounted turn signal light for vehicles, such as motorcycles, in particular, which utilizes high brightness LED lights mounted in a compact housing attachable to the mirror. The turn signal provides a brilliant light to the rear and side of a vehicle, while the housing has a wall to shield the eyes of the driver or rider.

Making turn signals visible on the road has long been a goal. Also it has been important to insure that the turn signals are noticed by persons and vehicles to the side and rear of the vehicle.

With the advent of very bright light emitting diodes (LEDs), which are small and brilliant, the opportunities for providing noticeable lights have become greater. It also is important to prevent the turn signals from distracting a driver or rider at a critical time, such as during a lane change or other turn. People have sought to obtain bright signal lights that are not in the line of vision of a driver or rider but are easily noticed by others.

### SUMMARY OF THE INVENTION

The present invention relates to a super bright LED turn signal light that can be mounted on the exterior mirrors of a vehicle, such as a motorcycle, which, when energized during a flashing turn signal, provides very bright, noticeable light at a height that other vehicles, such as automobiles, will easily see. A compact turn signal light housing is installed on the mirror itself, and fits inside the mirror housing on the outer end of the mirror. The housing has a wall with a reflective surface facing to the outer side and the lights face rearwardly and shine to the rear of the vehicle, while shielding the eyes of a driver or rider from the bright flashing light. Shielding the LED flash from the driver's eyes when the driver looks back for a space to make a signaled turn, such as in a lane change, or moving onto an approach or departure ramp, reduces the likelihood of a distraction.

### BRIEF DESCRIPTION OF THE DRAWINGS

FIG. 1 is a top plan schematic view of a vehicle, as shown a motorcycle, to illustrate a turn signal light according to the present installed on a rear view mirror;

FIG. 2 is an elevational view of the mirror on the right hand side of a vehicle (motorcycle) with the turn signal light of the present invention in position on the mirror;

FIG. 3 is a sectional view taken along line 3-3 in FIG. 2;

FIG. 4 is a side elevation view of the light of the present invention taken generally along line 4-4 in FIG. 2 with the mirror housing broken away; and

FIG. 5 is an enlarged sectional view taken on line 5-5 in FIG. 3.

### DESCRIPTION OF THE ILLUSTRATIVE EMBODIMENTS

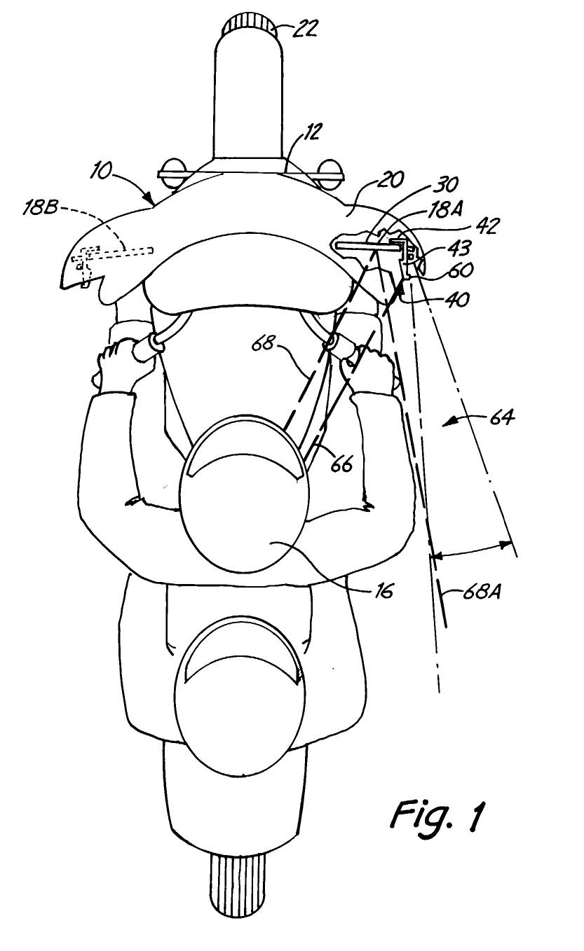

Referring to FIG. 1 for orientation, a vehicle 10, as shown a motorcycle, has a frame 12, and a seat on which a rider represented at 16 is seated. While shown generically, the motorcycle 10 includes rear view mirror assemblies on opposite sides thereof which are indicated at 18A and 18B. The two mirrors are in fact reverse images or mirror images of each other, so only the mirror assembly 18A will be shown in detail. The mirror assembly 18A is supported on suitable supports 20 back to the frame 12, and the mirror is mounted, as shown, so that it will turn with the front wheel 22 of the motorcycle,

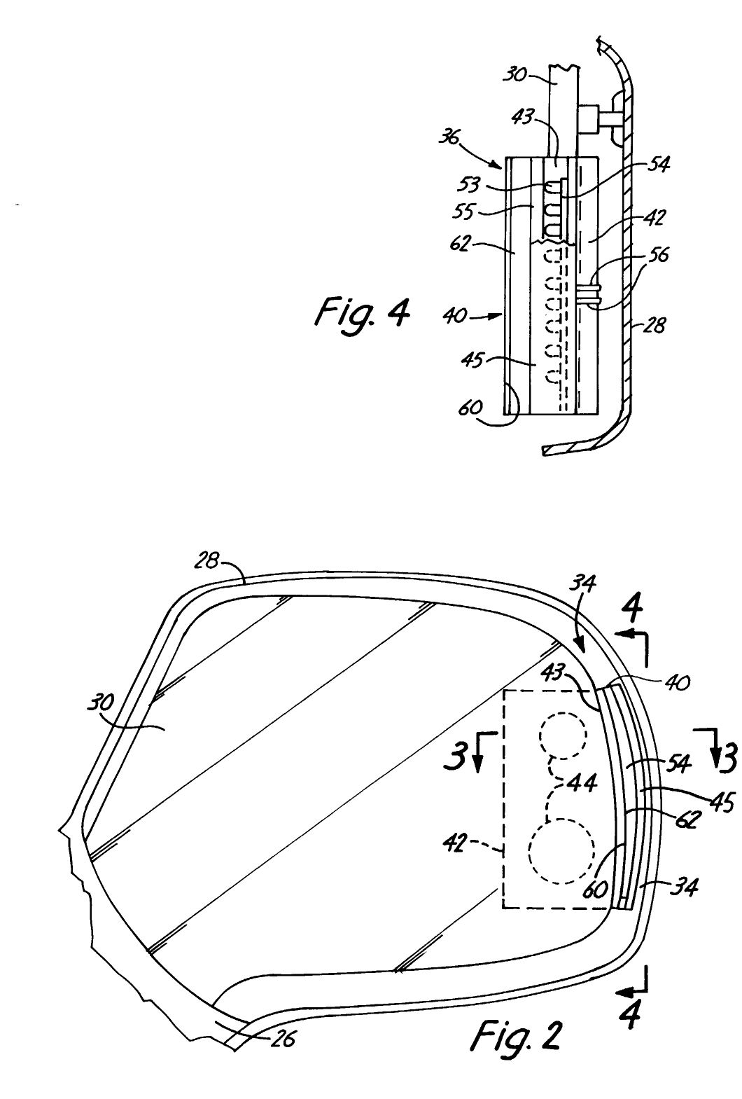

In FIG. 2, an elevational view of an exterior vehicle assembly mirror 18A, looking from the rear toward the front, is shown. The mirror has a support strut 26, and an outer housing at 28, which is formed sufficiently large to mount the mirror 30 on a suitable support so that it can be adjusted within the housing. If desired, the mirror can be adjusted at the mounting strut 26.

The housing 28 is generally formed of plastic, and is made so that it has a space indicated at 34 around the periphery of the mirror 30. This is a standard type mirror mounting, for many types of vehicles, and in order to provide for a bright, rear facing turn signal indicator, a turn signal assembly 36 is provided. The assembly 36 includes a support frame 40 which has a base flange 42 that is parallel to the mirror 30 and perpendicular to a main wall 43 of the flange. Wall 43 extends alongside the edge of the mirror and protrudes from the viewing surface of the mirror 30. High strength adhesive pads 44 are provided on the flange for securing the turn signal assembly support frame 40 to the backside of the mirror 30.

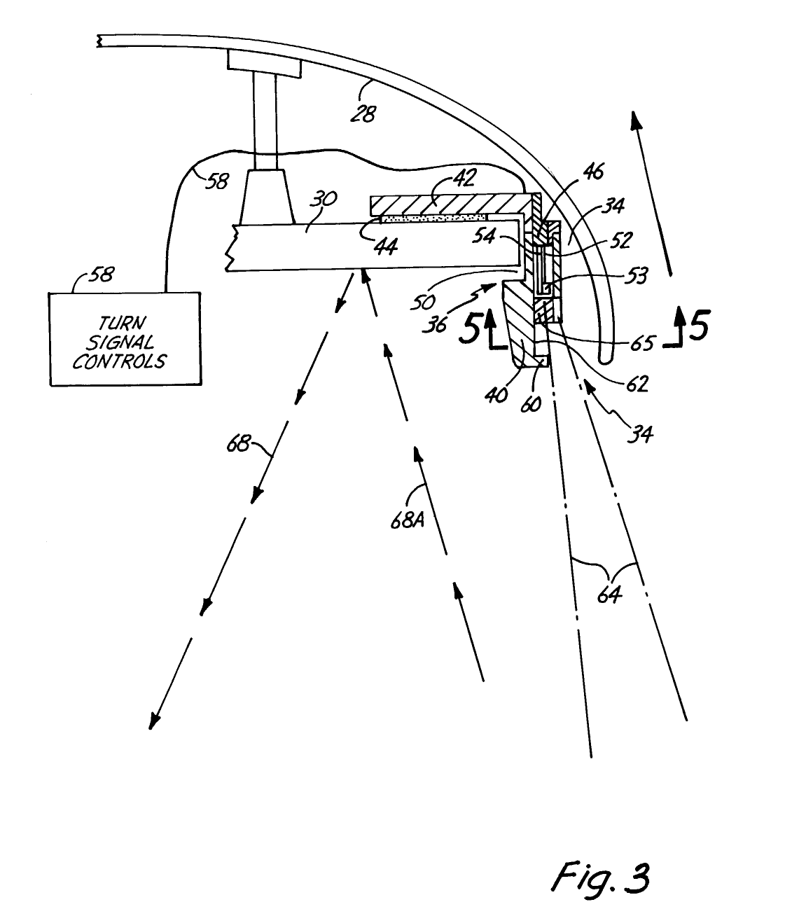

The frame 40 comprises a light support block which is adjacent the flange or wall 43 that extends vertically along the edge of the mirror, and is on the inside of the mirror housing 28, as shown. The wall 43 has a recess 50 (FIG. 3) for receiving the edge of the mirror 30. A recess or compartment 52 is defined between the outer surface of wall 43 and an opaque wall 45 that is also inside the mirror housing. High visibility or super bright signal grade LED lights 53 on a strip 54 are mounted in compartment 52 and the LEDs are positioned to shine light rearwardly through a covering lens 55. The wires 56 for powering the LED strip are threaded through the mirror housing 28. Wires 56 are connected to suitable turn signal controls indicated at 58. The turn signal controls are mounted on the handle bars of the motorcycle 10 or other vehicle with no cab, or on the interior of a vehicle having a cab, in a normal manner.

The LED turn signal assembly support frame 40, as shown in FIG. 3 extends rearwardly from the surface of mirror 30 and has an outwardly facing lip 60 at the outer (rear) edge of wall 43. The outwardly facing surface of the wall 43 is coated with a highly reflective material 62 such as chromium (See FIG. 5). The light from the LEDs 53 will be broadcast or radiated rearwardly of the space 34 between the edge of lip 60 and the mirror housing 28, as generally represented by the beam lines 64, when the turn signal is flashing.

Lens 55 is used so that the light beam is relatively tightly focused. The LEDs will flash brightly during turn signal operation and the reflector 62 will intensify the light flashes in laterally outward direction, but the rearwardly extending portion of wall 43 and lip 60 alongside the LED printed circuit board strip form an optical shield that prevents light from radiating or beaming at such an angle as to be seen by the driver or rider. The outer visual line of a driver's or rider's eye is indicated at 66 in FIG. 1, so the light is not radiated back to the driver. However, the image or sight line 68 to the driver or rider (also termed an operator) from the mirror 30 is still unrestricted, so that the driver will see rear images such as those along line 68A.

The optical shield formed by the opaque wall 43 of the housing 40 and the opaque lip 60 insures that the flashing light at the level of the rear view mirror will not distract the rider when the rider looks to the side and rear to see if there is traffic coming in the direction of the turn.

The LED strip 54 can have a sufficient length so that it shines brightly, and as shown, several separate LEDs 53 are on the strip in the form that is illustrated.

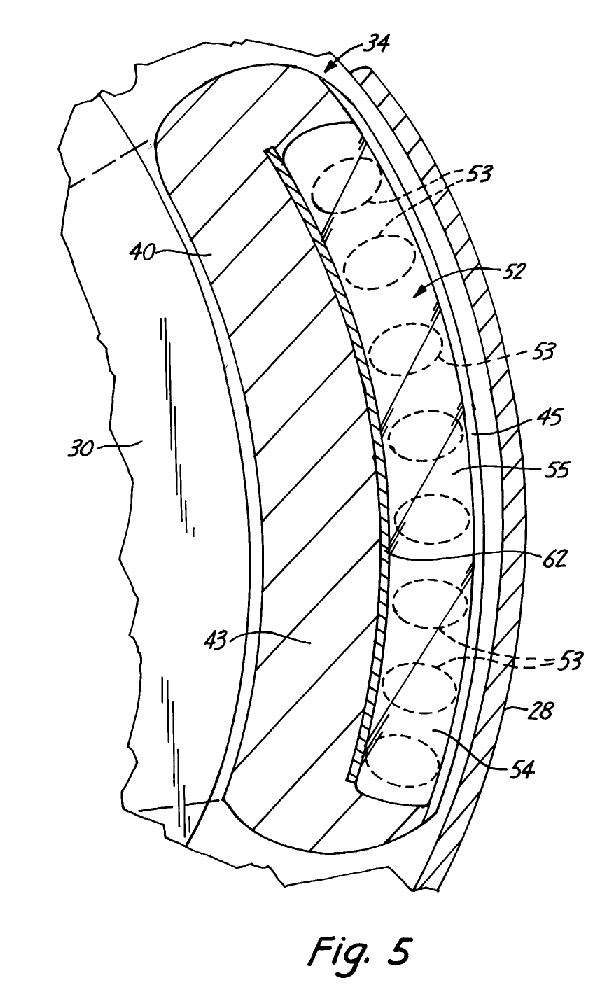

Since LEDs require little power, but provide bright light, they lend themselves well to use in turn signal sets for motorcycle. Mounting the turn signal light on the mirror brings the light up to a level that is easily seen by an automobile or other vehicle approaching from the side and rear of the vehicle (motorcycle) having exterior mirror mounted turn signal lights of the present invention. A mounting screw usually will permit removal of the mirror, and then the wall 42 can easily be attached to the back side of the mirror as shown in FIG. 4. Exterior mirrors of automobiles and trucks, all terrain vehicles, snowmobiles and the like also benefit from the mirror mounting.

The benefits of the present invention are great when used on a handlebar steered vehicle, since the need to have the turn signal noticed is great. The operator is also closer to the light source so the shielding also important.

Various forms of the LEDs can be used, but the light source comprising LEDs generally will have a vertically elongated length along an outer edge of the mirror 30, and will be positioned so that even without a mirror housing, it will form a bright turn signal, and the lip 60 and wall 43 extending rearward from the LEDs will provide the light shield to prevent glare and flashes from distracting the operator, whether a driver or rider.

Although the present invention has been described with reference to preferred embodiments, workers skilled in the art will recognize that changes may be made in form and detail without departing from the spirit and scope of the invention.

What is claimed is:

1. A turn signal light assembly for a vehicle having an exterior rear view mirror, the turn signal light assembly comprising a support housing supporting a turn signal light, said support housing having a flange for attachment to a rear view mirror, and a light wall adjacent the flange and the support housing having a wall portion extending in a selected direction from the flange, away from the flange beyond the light a sufficient distance to shield the light from direct view in a selected region in a first direction laterally of the light.

2. The turn signal light assembly of claim 1 wherein the support housing is elongated in a vertical direction when supported on a rear view mirror, and the turn signal light comprises a plurality of LEDs extending along the vertical direction.

3. The turn signal light assembly of claim 1, in combination with a mirror mounting the turn signal light assembly and a mirror housing, the mirror housing being spaced from an outer edge of the mirror, and the light support housing being positioned between the mirror housing and an outer edge of the mirror.

4. The turn signal light assembly of claim 2 wherein said support housing has a compartment for receiving the light, and an opaque lip spaced from the light and projecting from the wall portion laterally in an opposite direction from the first direction to provide shielding of light from radiating in a selected direction.

5. The turn signal light assembly of claim 1 wherein said flange has adhesive thereon for adhesively securing the housing to a backside of a mirror.

6. A turn signal assembly for a vehicle having an exterior rear view mirror, a turn signal light support housing secured to the mirror, a light source attached to the support housing and extending in a direction along an outer edge of the mirror, and the housing extending in direction perpendicular to the mirror a sufficient distance to block light from the light along a line of sight of an operator of the vehicle, while directing light rearwardly and laterally outwardly.

7. The turn signal assembly of claim 6 wherein the housing has a wall surface that has a reflective coating that faces generally laterally outwardly from the mirror and is spaced from the light source.

8. A turn signal light for mounting on a mirror on the exterior of a vehicle, the turn signal light comprising a housing, said housing being elongated in a first direction and having a wall extending in a second direction perpendicular to the first direction, said wall having an outwardly facing surface and an inwardly facing surface, a light source positioned on the wall adjacent one edge of the wall and outwardly of the outwardly facing surface, the light source being positioned to project light in a direction parallel to the outwardly facing surface, the wall being opaque to shield light from the light source from radiating in a selected direction laterally of the inwardly facing.

9. The turn signal light of claim 8 wherein the wall extends in the second direction farther than the light source, and a lip at an edge of said wall opposite from the edge adjacent which the light source is mounted, the lip extending perpendicular to the outwardly facing surface a selected distance.

10. The turn signal light of claim 9 wherein said outwardly facing surface has a reflective coating thereon.

11. The turn signal light of claim 9 and a lens extending from the outwardly facing surface and overlying said light source, said lens being between the light source and the lip.

12. The turn signal light of claim 8, and a mounting flange at the one edge of the wall adjacent the light source and extending generally perpendicular to the wall.

13. The turn signal light of claim 8 wherein said light source comprises a plurality of LEDs on a printed circuit strip extending along a line parallel to the first direction.

14. The turn signal light of claim 13 wherein there is a compartment formed adjacent the one edge of the wall, one side of the compartment being a continuation of the outwardly facing surface, the LEDs being mounted in the compartment.

15. The turn signal light of claim 14 and a lens overlying the light to close an open side of the compartment facing in the second direction.

16. The turn signal light of claim 14, wherein the vehicle is a motorcycle, the wall extending in the second to shield the LEDs sufficiently to block light therefrom from being directly visible to an operator of the motorcycle.
